(19) United States
(12) Patent Application Publication
(10) Pub. No.: US 2015/0160419 A1
(43) Pub. Date: Jun. 11, 2015

(54) OPTICAL FIBER WITH FERRULE AND MANUFACTURING METHOD OF THE SAME

(71) Applicant: SUMITOMO ELECTRIC INDUSTRIES, LTD., Osaka (JP)

(72) Inventor: Itaru SAKABE, Yokohama-shi (JP)

(21) Appl. No.: 14/560,075

(22) Filed: Dec. 4, 2014

(30) Foreign Application Priority Data
Dec. 6, 2013 (JP) 2013-253079
Dec. 6, 2013 (JP) 2013-253088

(51) Int. Cl. G02B 6/38

(52) U.S. Cl. CPC G02B 6/3833; G02B 6/3865

(57) ABSTRACT

An optical fiber with a ferrule, includes an optical fiber having a core part and a cladding part, and a ferrule to which an end of the optical fiber is fixed. The ferrule is formed integrally to the optical fiber and a resin constructing the ferrule directly abuts on the optical fiber.

### BACKGROUND

### Technical Field

The present invention relates to an optical fiber with a ferrule and a manufacturing method of the optical fiber.

An optical fiber with a ferrule, in which the ferrule is attached to the end of the optical fiber, is known by Patent Reference 1 etc.

Such an optical fiber with the ferrule is manufactured through many steps. For example, a coating of a coated optical fiber is removed, and a glass end face of the optical fiber is cut, and a two-liquid adhesive is kneaded together, and a hole for fiber fixing formed in the ferrule is filled with the adhesive, and the optical fiber is inserted into the hole for fiber fixing, and the adhesive is cured, and an end face of the ferrule is polished to thereby manufacture the optical fiber with the ferrule.

Also, connection between devices by an optical fiber with a ferrule is known by Patent Reference 2 etc.

### PRIOR ART REFERENCE

### Patent Reference

[Patent Reference 1] JP-A-2011-248244

[Patent Reference 2] JP-A-2008-3203

Since the manufacturing method of the optical fiber with the ferrule has many steps as described above, a manufacturing cost of the optical fiber with the ferrule runs up.

Also, the optical fiber as described above requires the optical fiber with the ferrule in which a numeral aperture NA of the end in a longitudinal direction is smaller than a numeral aperture NA of the center in the longitudinal direction.

### SUMMARY

Exemplary embodiments of the invention provide an optical fiber with a ferrule capable of being easily manufactured, and a manufacturing method of the optical fiber.

Also, exemplary embodiments of the invention provide an optical fiber with a ferrule having a small numeral aperture NA in the end.

An optical fiber with a ferrule, according to an exemplary embodiment of the invention, comprises:

an optical fiber having a core part and a cladding part; and

a ferrule to which an end of the optical fiber is fixed,

wherein the ferrule is formed integrally to the optical fiber and a resin constructing the ferrule directly abuts on the optical fiber.

A manufacturing method of an optical fiber with a ferrule, according to an exemplary embodiment of the invention, comprises:

preparing a mold for forming a ferrule;

inserting an optical fiber and a resin constructing the ferrule into the mold; and

curing the resin and integrating the optical fiber with the ferrule.

An optical fiber with a ferrule, according to an exemplary embodiment of the invention, comprises:

an optical fiber including a core part, and a plastic part formed on an outside of the core part; and

a ferrule formed on an end of the optical fiber,

wherein the ferrule is fixed to an end of the optical fiber in which the plastic part is removed by an adhesive with a refractive index higher than that of the plastic part.

An optical fiber with a ferrule, according to an exemplary embodiment of the invention, comprises:

an optical fiber including a core part, and a plastic part formed on an outside of the core part; and

a ferrule fixed to an end of the optical fiber,

wherein a resin constructing the ferrule directly abuts on an end of the optical fiber in which the plastic part is removed, and the resin constructing the ferrule has a refractive index higher than that of the plastic part.

According to the exemplary embodiment of the invention, it is possible to provide an optical fiber with a ferrule capable of being easily manufactured, and a manufacturing method of the optical fiber.

Also, according to the exemplary embodiment of the invention, it is possible to provide an optical fiber with a ferrule having a small numeral aperture NA in the end.

### BRIEF DESCRIPTION OF THE DRAWINGS

FIG. 1 is a schematic diagram of an optical fiber with a ferrule according to an embodiment of the invention.

FIGS. 2A to 2D are schematic diagrams showing a manufacturing method of an optical fiber with a ferrule according to a first embodiment of the invention.

FIGS. 3A to 3C are schematic diagrams showing a manufacturing method of an optical fiber with a ferrule according to a second embodiment of the invention.

FIG. 4 is a schematic diagram of an optical fiber with a ferrule according to a modified example of the invention.

FIGS. 5A to 5E are diagrams describing a manufacturing method of an optical fiber with a ferrule according to a comparative example.

FIG. 6A is a diagram showing the whole of an optical fiber with a ferrule according to a third embodiment of the invention.

FIG. 6B is an enlarged schematic diagram showing an end in a longitudinal direction of the optical fiber with the ferrule according to the third embodiment of the invention.

FIG. 7A is a diagram showing refractive index distribution of the end of the optical fiber with the ferrule as shown in FIG. 6B.

FIG. 7B is a diagram showing refractive index distribution of a portion other than the end of the optical fiber with the ferrule as shown in FIG. 6A.

FIG. 8 is an enlarged view of the end of an optical fiber with a ferrule in a longitudinal direction according to a modified example 1 of the invention.

FIG. 9A is a diagram showing refractive index distribution of an end in a longitudinal direction of an optical fiber with a ferrule according to a modified example 2 of the invention.

FIG. 9B is a diagram showing refractive index distribution of a portion other than the end of the optical fiber with the ferrule according to the modified example 2 of the invention

FIG. 10 is a diagram showing refractive index distribution of an end in a longitudinal direction of an optical fiber with a ferrule according to a modified example 3 of the invention.

FIG. 11A is a diagram showing refractive index distribution of the end of the optical fiber with the ferrule as shown in FIG. 10.

FIG. 11B is a diagram showing refractive index distribution of a portion other than the end of the optical fiber with the ferrule as shown in FIG. 10.

### DETAILED DESCRIPTION

### Outline of Embodiment of the Invention

First, an outline of an embodiment of the invention will be described.

One embodiment of an optical fiber with a ferrule according to the invention is

(1) an optical fiber with a ferrule, including:

an optical fiber having a core part and a cladding part, and

a ferrule to which an end of the optical fiber is fixed,

wherein the ferrule is formed integrally to the optical fiber and a resin constructing the ferrule directly abuts on the optical fiber.

According to the configuration of (1), since the ferrule is formed integrally together with the optical fiber, the optical fiber with the ferrule can be obtained easily.

(2) A refractive index of the ferrule may be higher than a refractive index of the cladding part or the core part.

According to the configuration of (2), since a numeral aperture becomes small in the end of the optical fiber with the ferrule where the ferrule is provided, the optical fiber with the ferrule having propagation-resistant high-order mode light and good transmission characteristics can be obtained.

(3) Transmittance of light at a wavelength of 850 nm to 1600 nm of the ferrule may be lower than transmittance of light at the same wavelength of the cladding part or the core part.

According to the configuration of (3), since high-order mode light blurring from the core part to the outside enters the ferrule with low transmittance, the high-order mode light is attenuated. Accordingly, the optical fiber with the ferrule having the propagation-resistant high-order mode light and good transmission characteristics can be obtained.

(4) The ferrule may have a fiber covering part with which the end of the optical fiber is covered, and a lens surface may be formed on the fiber covering part of the ferrule.

According to the configuration of (4), the lens part can increase efficiency of optical coupling between an external optical component and the optical fiber with the ferrule.

(5) An end face of the optical fiber may be a convex curved surface.

According to the configuration of (5), air bubbles which may be caught in the case of integrating the ferrule with the optical fiber are resistant to being positioned in the end of the core part. As a result, the highly-reliable optical fiber with the ferrule can be provided.

One embodiment of a manufacturing method of an optical fiber with a ferrule according to the invention is

(6) a manufacturing method of an optical fiber with a ferrule, including:

preparing a mold for forming a ferrule,

inserting an optical fiber and a resin constructing the ferrule into the mold, and

curing the resin and integrating the optical fiber with the ferrule.

According to the method of (6), since the resin with the inside of the mold is filled is cured and the ferrule is integrated together with the optical fiber, the need for polishing an end face of the optical fiber or using an adhesive like a related art is eliminated, and the optical fiber with the ferrule can be manufactured easily.

(7) An optical fiber may be inserted into the mold filled with the resin constructing the ferrule to cure the resin.

(8) The optical fiber may be arranged in the mold after the optical fiber is cut by a laser.

According to the method of (8), a simple method for cutting the optical fiber by the laser can provide the highly-reliable optical fiber with the ferrule, in which air bubbles which may be caught in the case of arranging the optical fiber in the mold filled with the resin are resistant to being positioned in the end of the core part.

One embodiment of an optical fiber with a ferrule according to the invention is

(9) an optical fiber with a ferrule, including:

an optical fiber including a core part, and a plastic part formed on an outside of the core part, and

a ferrule formed on an end of the optical fiber,

wherein the ferrule is fixed to an end of the optical fiber in which the plastic part is removed by an adhesive with a refractive index higher than that of the plastic part.

Another embodiment of an optical fiber with a ferrule according to the invention is

(10) an optical fiber with a ferrule, including:

an optical fiber including a core part, and a plastic part formed on an outside of the core part, and

a ferrule fixed to an end of the optical fiber,

wherein a resin constructing the ferrule directly abuts on an end of the optical fiber in which the plastic part is removed, and the resin constructing the ferrule has a refractive index higher than that of the plastic part.

According to the configurations of (9) and (10), since the adhesive or the ferrule with the high refractive index is positioned in the outside of the core part in the ferrule, the optical fiber with the ferrule in which a numeral aperture of the end in a longitudinal direction is smaller than a numeral aperture of the center in the longitudinal direction can be obtained.

(11) Refractive index distribution of the core part in a radial direction may be α-power profile.

According to the configuration of (11), since high-order mode light propagated by the core part of the α-power profile is blocked by the end of the optical fiber with the ferrule, the optical fiber with the ferrule having good transmission characteristics can be provided.

(12) The plastic part may be a cladding part of the optical fiber.

(13) The core part may be made of a resin.

(14) The optical fiber may have a cladding part which is formed on an outside of the core part and is made of glass with a refractive index lower than that of the core part,

the plastic part of the optical fiber may be a coating layer with which the cladding part is covered, and

a thickness of the cladding part may be 10 μm or less.

The invention can also be applied to the optical fiber with the ferrule using the optical fiber with the configurations of (12) to (14).

(15, 16) Transmittance of light at a wavelength of 850 nm to 1600 nm of the resin constructing the ferrule or transmittance of light at a wavelength of 850 nm to 1600 nm of the adhesive may be 1%/cm or less.

(17, 18) A refractive index of the resin constructing the ferrule or a refractive index of the adhesive may be lower than a refractive index of the core part.

According to the configurations of (15) to (18), since high-order mode light blurring to a region of the adhesive or the resin constructing the ferrule is attenuated by a material with low transmittance, the high-order mode light is not propagated and the optical fiber with the ferrule having good transmission characteristics can be provided.

### DETAILS OF EMBODIMENT OF THE INVENTION

An example of an embodiment of an optical fiber with a ferrule and a manufacturing method of the optical fiber according to the invention will hereinafter be described with reference to the drawings. In addition, the invention is not limited to these illustrations, and intends to include the contents shown by the claims, meanings equivalent to the claims and all the changes within the claims.

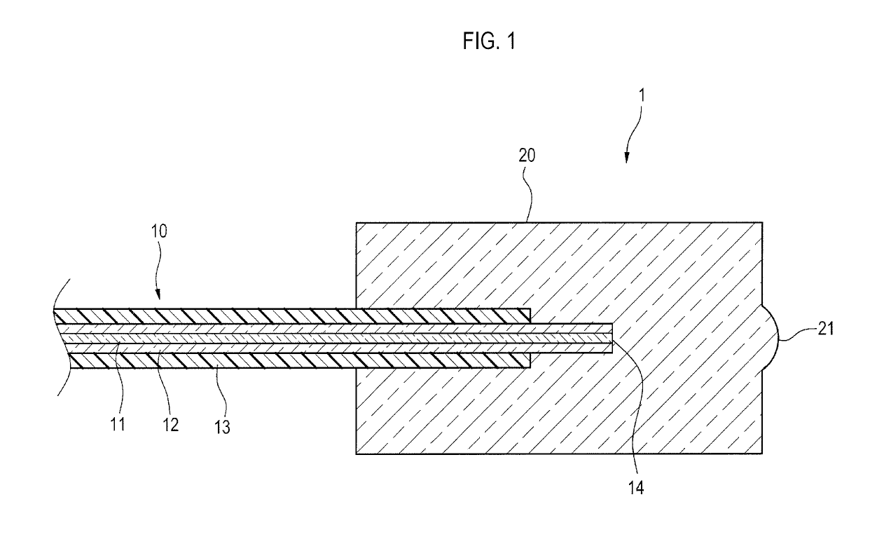

FIG. 1 is a schematic diagram of an optical fiber with a ferrule according to the present embodiment.

As shown in FIG. 1, an optical fiber 1 with a ferrule according to the embodiment includes an optical fiber 10, and a ferrule 20 to which the end of the optical fiber 10 is fixed. The optical fiber 1 with the ferrule is used for, for example, making optical connection between a light emitting element and a light receiving element of the outside. The optical connection between the light emitting element and the light receiving element can be made by optically connecting one longitudinal end of the optical fiber 1 with the ferrule to the light emitting element and optically connecting the other longitudinal end of the optical fiber 1 with the ferrule to the light receiving element.

The optical fiber 10 includes a core part 11, a cladding part 12 formed on the outside of the core part, and a coating part 13 formed on the outside of the cladding part 12. An end face 14 formed on the end of the optical fiber 10 is a smooth surface. An optical signal transmitted inside the optical fiber 10 is emitted from the smooth end face 14 of this optical fiber 10 to the outside and also, an optical signal from the outside is launched from the end face 14 of this optical fiber 10. In the end of the optical fiber 10, the coating part 13 is removed and the outer periphery of the cladding part 12 is exposed from the coating part 13.

In the embodiment, the ferrule 20 is a member with substantially a rectangular parallelepiped shape. The ferrule 20 is formed of a transparent resin. As the resin used in the ferrule 20, ULTEM (registered trademark) (SABIC Inc.) of an amorphous thermoplastic polyetherimide resin or TERALINK (registered trademark) (Sumitomo Electric Fine Polymer, Inc.) having good heat resistance and high transmittance of light at the wavelength of 1300 nm to 1600 nm used in an optical signal is used suitably. Moreover, an acrylate resin, an epoxy resin, a polycarbonate resin, a polyamide resin, etc. can be used.

Also, a refractive index of the resin used in the ferrule 20 is preferably higher than a refractive index of the core part 11 abutting on the ferrule 20 or the cladding part 12 of the optical fiber 10. And, a refractive index difference between the ferrule 20 and the core part 11 becomes larger than a refractive index difference between the cladding part 12 and the core part 11. A numeral aperture is expressed by {(a refractive index of the core part)²−(a refractive index of a region of the outside of the core part)}^{1/2}. As a result, a refractive index difference in the end covered with the ferrule 20 in a longitudinal direction of the optical fiber 1 with the ferrule becomes smaller than a numeral aperture in the portion other than the end which is not covered with the ferrule 20 in the longitudinal direction.

Bending characteristics of the optical fiber 1 with the ferrule can be improved by increasing a refractive index difference between the core and the periphery of the core in the portion other than the end in the longitudinal direction of the optical fiber in this manner. Also, a spread angle of light emitted from the end face of the optical fiber 10 can be decreased by decreasing the numeral aperture in the end in the longitudinal direction. Also, by preventing propagation of high-order mode light, a signal with a large group delay mode is not transmitted and the optical fiber 1 with the ferrule having good transmission characteristics can be obtained.

Also, transmittance of light of the ferrule 20 is preferably lower than transmittance of light of the core part 11 or the cladding part 12 of the optical fiber 10. The optical fiber with the ferrule having good transmission characteristics can be obtained by attenuating high-order mode light blurring from the core part 11 to the outside by decreasing the transmittance of the ferrule 20. Here, the transmittance of light of the ferrule 20 means transmittance to light at a wavelength of 1300 nm to 1600 nm used as an optical signal.

In the portion (one example of a fiber covering part) with which the end of the optical fiber 10 is covered in the ferrule 20, a lens surface 21 is formed on an extension in the longitudinal direction of the optical fiber 10. More concretely, the lens surface 21 is formed on an outer surface of the ferrule 20 of the extension in the longitudinal direction of the optical fiber 10.

An optical signal emitted from the optical fiber 10 is inputted to an external optical component such as a light receiving element through this lens surface 21. Also, an optical signal inputted from the outside is launched to the optical fiber 10 through this lens surface 21. Efficiency of optical coupling between the optical fiber and the external optical component can be increased by inputting and outputting the optical signal through the lens surface 21 in this manner. In addition, the ferrule 20 may be constructed so as not to form this lens surface 21.

This ferrule 20 is formed integrally to the optical fiber 10 so as to cover the end of the optical fiber 10, and a resin constructing the ferrule 20 directly abuts on the optical fiber 10.

By such a configuration, manufacture is easy since the ferrule 20 is formed integrally to the optical fiber 10. Also, as shown in Patent Reference 1, an adhesive is not interposed between the optical fiber and the ferrule, with the result that connection strength is not decreased due to, for example, occurrence of poor connection or deterioration of an adhesive in use of the optical fiber with the ferrule.

### Manufacturing Method

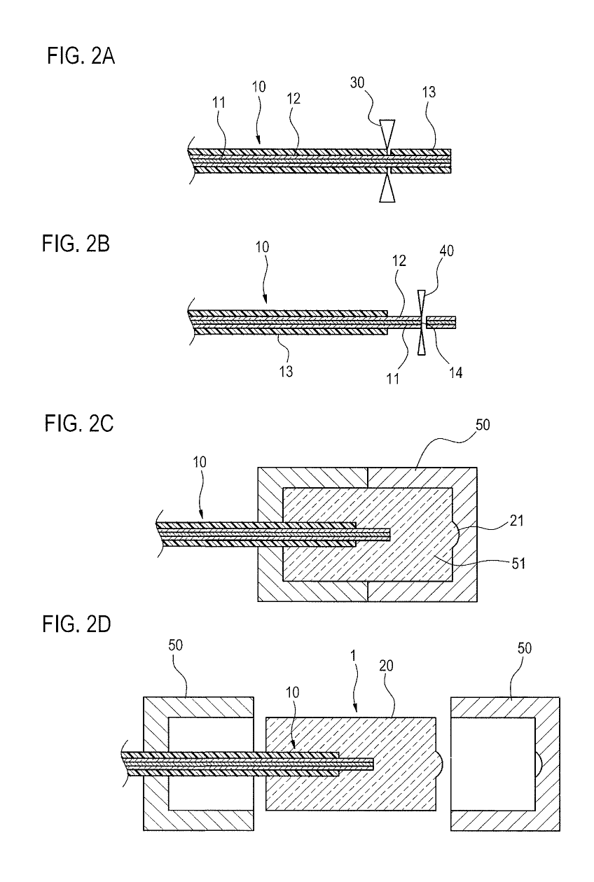

Next, a manufacturing method of the optical fiber 1 with the ferrule described above will be described using FIGS. 2A to 2D. FIGS. 2A to 2D are schematic diagrams showing the manufacturing method of the optical fiber 1 with the ferrule according to a first embodiment of the invention.

First, as shown in FIG. 2A, the optical fiber 10 is prepared, and a coating removal cutter 30 is put to an outer peripheral surface of the coating part 13 in the vicinity of the end, and the coating part 13 is notched. Only the coating part 13 of the distal end beyond its notch is removed to expose an outer peripheral surface of the cladding part 12.

Next, as shown in FIG. 2B, a cutter 40 is pressed on the outer peripheral surface of the exposed cladding part 12 and the cladding part 12 is flawed and further using this flaw, the ends of the core part 11 and the cladding part 12 are broken off. The end face 14 of the optical fiber 10 becomes a smooth surface by cutting the end face of the optical fiber 10 in this manner.

Then, as shown in FIG. 2C, a mold 50 in which a cavity 51 is formed is prepared. Then, the inside of the cavity 51 is filled with a resin constructing the ferrule 20. The end of the optical fiber 10 is arranged inside the cavity 51 of the mold 50 filled with the resin. Further, the resin of the inside of the mold 50 is cured to integrate the optical fiber 10 with the ferrule 20.

In addition, when the optical fiber 10 is arranged inside the cavity 51, the same resin as the resin forming the ferrule may be applied to an outer periphery of the optical fiber 10 to improve adhesion between the optical fiber 10 and the resin forming the ferrule 20. The resin constructing the ferrule 20 is preferably an ultraviolet curable resin or a thermosetting resin.

As shown in FIG. 2D, after the resin is cured, the mold 50 is opened, and the optical fiber 1 with the ferrule in which the optical fiber 10 is integrated with the ferrule 20 is taken out of the mold 50. By such a method, the optical fiber 1 with the ferrule is manufactured easily.

Next, a manufacturing method of an optical fiber with a ferrule of a related art according to a comparative example will be described, and an effect of the manufacturing method of the optical fiber 1 with the ferrule according to the embodiment of the invention described above will be described in detail.

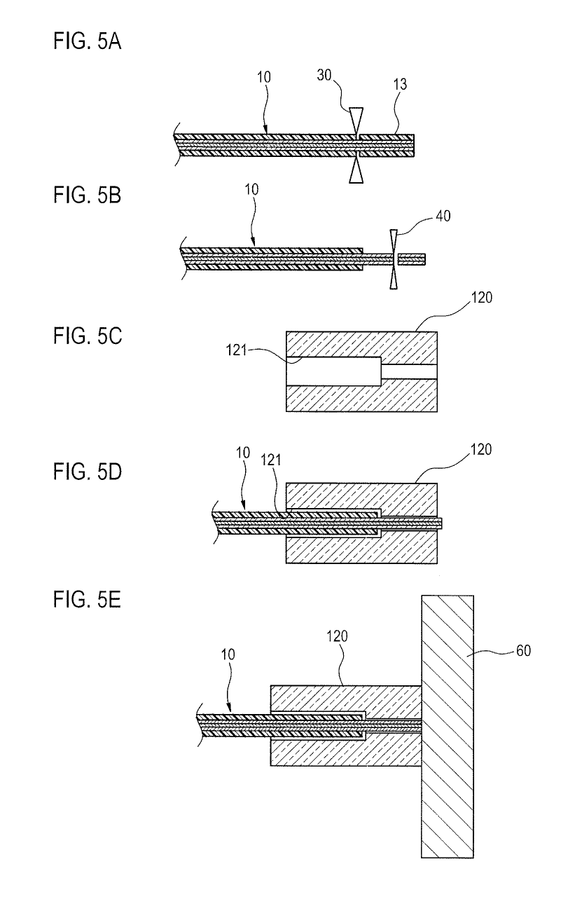

FIGS. 5A to 5E are diagrams describing the manufacturing method of the optical fiber with the ferrule according to the comparative example different from the invention.

First, like the embodiment described above, as shown in FIGS. 5A and 5B, a coating part 13 of an optical fiber 10 is removed using a coating removal cutter 30, and the optical fiber 10 is cut so as to have a desired length using a cutter 40. In addition, it is unnecessary to process an end face of the optical fiber 10 in a smooth surface in a step shown in FIG. 5B.

Next, as shown in FIG. 5C, a ferrule 120 having a through hole 121 is prepared. An adhesive is applied to the inside of the through hole 121 of this ferrule 120. As the adhesive, a two-liquid type adhesive is used. After the two-liquid adhesive is kneaded together, the adhesive kneaded together is applied to the through hole 121.

Then, as shown in FIG. 5D, the optical fiber 10 is inserted into the through hole 121 to which the adhesive is applied so that the end of the optical fiber 10 extends through the ferrule 120. When an end face of the optical fiber 10 is positioned inside the through hole 121, the adhesive adheres to the end face of the optical fiber 10 to lose good optical connection. Because of this, the optical fiber 10 is inserted into the through hole 121 so that the end of the optical fiber 10 extends through the through hole 121. With the optical fiber 10 inserted into the through hole 121, the adhesive is cured and the optical fiber 10 is fixed to the ferrule 120 using the adhesive.

Further, as shown in FIG. 5E, the end face of the optical fiber 10 is polished using a polishing machine 60, and the end face of the optical fiber 10 is smoothed. Accordingly, the optical fiber with the ferrule is manufactured.

In the manufacturing method according to the comparative example shown in FIGS. 5A to 5E, in a step of applying the adhesive shown in FIG. 5C, it is necessary to accurately align a nozzle for applying the adhesive with the through hole 121, and effort is spent. Also, a step of polishing the end face of the optical fiber 10 shown in FIG. 5A requires effort. This is because a long time is required since the ferrule 120 is also polished together with the end face of the optical fiber 10 so as to surely polish the end face of the optical fiber 10. Also, in the case of using the ferrule 120 made of ceramics such as zirconia, more time is required and also, the cost of a polishing material runs up.

On the other hand, according to the manufacturing method of the optical fiber 1 with the ferrule according to the embodiment shown in FIGS. 2A to 2D, the ferrule 20 is formed by integral molding to the optical fiber 10, with the result that the optical fiber 1 with the ferrule can be manufactured extremely easily as compared with the step of applying the adhesive. Also, it is unnecessary to polish the end face of the optical fiber 10 together with the ferrule 20, and the need for the step of polishing the end face of the optical fiber 10 shown in FIG. 5D requiring time and cost is eliminated. As a result, manufacturing time can be shortened and also, a manufacturing cost can be reduced.

### Second Embodiment

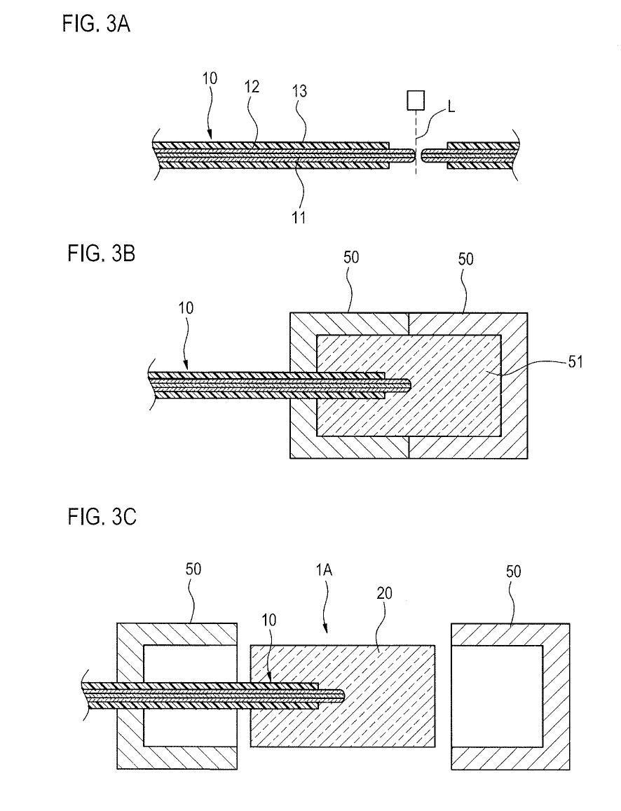

In addition, the manufacturing method of the optical fiber 1 with the ferrule according to the first embodiment described above gives the example of cutting the end face of the optical fiber 10 by the cutter 40, but the invention is not limited to this example. The end of the optical fiber 10 may be melted down by a laser. FIGS. 3A to 3C are schematic diagrams showing a manufacturing method of an optical fiber 1A with a ferrule according to a second embodiment of the invention.

First, as shown in FIG. 3A, the end of an optical fiber 10 is irradiated with a laser L, and the optical fiber 10 is cut in a desired length. By irradiating the end with the laser L, the optical fiber 10 is partially melted in the end. Also, in a portion with which the laser L is irradiated and the vicinity of the portion, a coating part 13 is largely thermally shrunk to thereby expose an outer peripheral surface of a cladding part 12. Also, surface tension acts on components of the cladding part 12 and a core part 11 melted in this time, and an end face of the optical fiber 10 becomes a convex curved surface.

Next, as shown in FIG. 3B, the optical fiber 10 having the end face of the convex curved surface is arranged in a mold 50 filled with a resin constructing a ferrule 20. After the resin is cured, the mold 50 is opened and the optical fiber 1A with the ferrule is taken out as shown in FIG. 3C.

According to such a manufacturing method of the optical fiber 1A with the ferrule, like the first embodiment described above, the need for a step of polishing and a step of applying an adhesive is eliminated, and the optical fiber 1A with the ferrule can be manufactured easily. Further, the manufacturing method of the optical fiber 1A with the ferrule according to the present embodiment facilitates a cutting step and a coating removal step of the optical fiber 10. Also, since the end face of the optical fiber 10 is the convex curved surface, even when air bubbles are caught between the resin and the optical fiber 10 in the case of arranging the optical fiber 10 in the resin of the inside of the mold 50, the air bubbles tend to move to the outer peripheral side of the optical fiber 10 along the convex curved surface and are resistant to remaining on the end face of the core part 11 of the optical fiber 10. As a result, the optical fiber 1A with the ferrule having high efficiency of optical coupling can be obtained.

### Modified Example

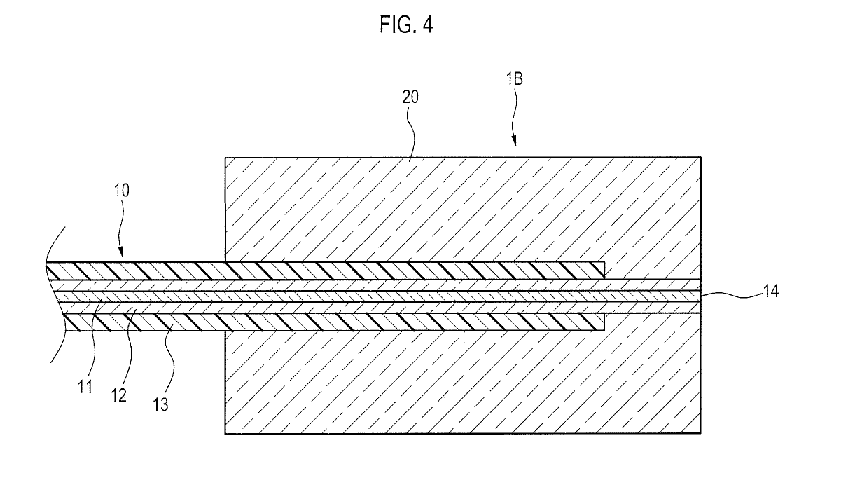

In addition, the first and second embodiments described above give the example of positioning the end face of the optical fiber 10 inside the ferrule 20, but as shown in FIG. 4, an end face 14 of an optical fiber 10 may be exposed to an outer peripheral surface of a ferrule 20. For example, when the optical fiber 10 is arranged inside the mold 50 shown in FIG. 2C or FIG. 3B, the end face of the optical fiber 10 can be pressed on a surface of the mold 50 to thereby easily manufacture an optical fiber 1B with a ferrule, in which the end face of the optical fiber 10 is exposed to the outside of the ferrule 20.

### Third Embodiment

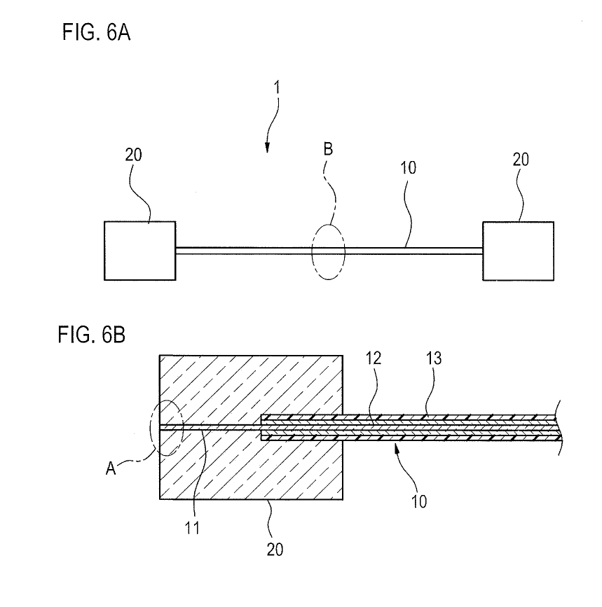

FIGS. 6A and 6B are schematic diagrams of an optical fiber with a ferrule according to a third embodiment of the invention. FIG. 6A shows the whole, and FIG. 6B is an enlarged schematic diagram showing the end in a longitudinal direction.

As shown in FIG. 6A, an optical fiber 1 with a ferrule according to the present embodiment includes an optical fiber 10, and ferrules 20 fixed to both ends of the optical fiber 10 in the longitudinal direction. The optical fiber 1 with the ferrule is used for, for example, making optical connection between a light emitting element and a light receiving element of the outside. The optical connection between the light emitting element and the light receiving element can be made by optically connecting one longitudinal end of the optical fiber 1 with the ferrule to the light emitting element and optically connecting the other longitudinal end of the optical fiber 1 with the ferrule to the light receiving element.

The optical fiber 10 includes a core part 11, a cladding part 12 formed on the outside of the core part 11, and a coating part 13 formed on the outside of the cladding part 12. An optical signal transmitted inside the optical fiber 10 is emitted from an end face of the optical fiber 10 to the outside and also, an optical signal from the outside is launched from the end face of this optical fiber 10. In the end of the optical fiber 10, the cladding part 12 and the coating part 13 are removed and the outer periphery of the core part 11 is exposed to the outside.

In the embodiment, the core part 11 of the optical fiber 10 is made of pure quartz glass or Ge-doped quartz glass, and the cladding part 12 is formed of plastic such as an acrylate fluoride resin. The coating part 13 is formed of plastic such as urethane acrylate. In the embodiment, the cladding part 12 and the coating part 13 correspond to a plastic part.

In the embodiment, the ferrule 20 is a member with substantially a cylindrical shape or a rectangular parallelepiped shape. The ferrule 20 is formed of a resin. As the resin used in the ferrule 20, an acrylate resin, an epoxy resin, a polycarbonate resin, a polyamide resin, etc. can be used. Transmittance in light at a range of a wavelength of 850 nm to 1600 nm of an optical signal of the resin constructing this ferrule 20 is preferably 1%/cm or less.

Inside this ferrule 20, the cladding part 12 and the coating part 13 corresponding to the plastic part are removed to expose the end of the core part 11 made of glass. An outer peripheral surface of the exposed core part 11 directly abuts by the resin constructing the ferrule 20.

Such an optical fiber 1 with the ferrule can be obtained by removing the cladding part 12 and the coating part 13 in the end of the optical fiber 10 and exposing the core part 11 and arranging this optical fiber 10 in a mold for molding the ferrule 20 filled with the resin and curing the resin.

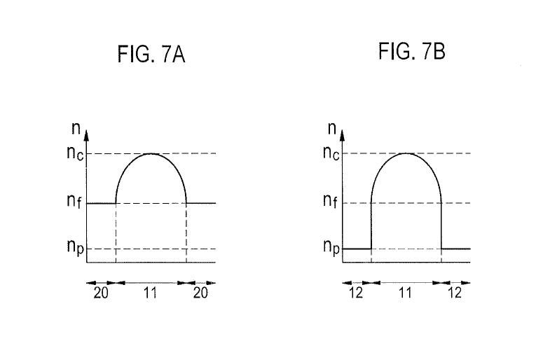

FIGS. 7A and 7B are diagrams showing refractive index distribution of the optical fiber 1 with the ferrule in a radial direction. FIG. 7A shows refractive index distribution of the end (region A of FIG. 6B) of the optical fiber 1 with the ferrule in a longitudinal direction. FIG. 7B shows refractive index distribution of the center (region B of FIG. 6A) of the optical fiber 1 with the ferrule in the longitudinal direction.

In the embodiment, as shown in FIGS. 7A and 7B, a GI fiber with α-power profile in which a refractive index of the core part 11 changes in a radial direction is used as the optical fiber 10. This GI fiber is used in transmission of multimode light. The core part 11 has refractive index distribution in which the refractive index is the highest in the center of the radial direction and the refractive index becomes lower toward the outer periphery. In the subsequent description, the highest refractive index of the center of the core part 11 is called a refractive index nc of the core part 11.

As shown in FIGS. 7A and 7B, a refractive index nf of the ferrule 20 is set higher than a refractive index np of the cladding part 12 made of plastic (nf>np).

A numeral aperture NA1 of the end (region A) of the optical fiber 1 with the ferrule in the longitudinal direction is expressed by the following formula (1) using the refractive index nc of the core part 11 and the refractive index nf of the ferrule 20.

NA1={(nc)²−(nf)}^{1/2} (1)

A numeral aperture NA2 of the portion (for example, region B) other than the end of the optical fiber 1 with the ferrule in the longitudinal direction is expressed by the following formula (2) using the refractive index nc of the core part 11 and the refractive index np of the cladding part 12.

NA2={(nc)²−(np)²}^{1/2} (2)

Since the refractive index nf of the ferrule 20 is set higher than the refractive index np of the cladding part 12 herein, the numeral aperture NA1 of the end (region A) of the optical fiber 1 with the ferrule in the longitudinal direction becomes smaller than the numeral aperture NA2 of the center (region B) in the longitudinal direction (NA1<NA2). Accordingly, the optical fiber 1 with the ferrule having the small numeral aperture in the end in the longitudinal direction can be obtained.

Incidentally, in recent years, a speedup in a transmission rate of an optical fiber desires an increase in an electron transfer rate of a light receiving element optically connected to the optical fiber. Hence, it is contemplated to increase an operation rate of the light receiving element by decreasing the dimensions of the light receiving element.

On the other hand, the optical fiber desires characteristics in which light is resistant to leakage even for bending. It is useful to largely set a refractive index difference with respect to a core part in order to reduce a bend loss. However, when the refractive index difference is largely set, the numeral aperture NA becomes large. As a result, there is fear that light emitted from the optical fiber spreads widely and all the light emitted from the optical fiber is not coupled to a small light receiving element. Also, when the refractive index difference is large, high-order mode light with a large group delay tends to be coupled to the light receiving element and transmission characteristics may be lost.

However, according to the optical fiber 1 with the ferrule according to the embodiment described above, in the portion other than the end in the longitudinal direction, the refractive index np of the cladding part 12 is set sufficiently lower than the refractive index nc of the core part 11 and thereby, the refractive index difference becomes large and the bend loss can be reduced.

Also, in the end A in the longitudinal direction, the numeral aperture NA1 of the end A in the longitudinal direction is set smaller than the numeral aperture NA2 of the center B in the longitudinal direction as described above. As a result, light emitted from the optical fiber 10 does not spread widely, and optical connection can be made with high efficiency of optical coupling even in the case of being optically connected to the small light receiving element. Also, since the refractive index difference is small, the high-order mode light is not propagated and good transmission characteristics can be obtained.

In addition, in the end A of the optical fiber 1 with the ferrule in the longitudinal direction, since the optical fiber 10 is protected by the ferrule 20, the optical fiber 10 is not bent and even when the refractive index difference between the core part 11 and the cladding part 12 is large, the bend loss presents no problem.

Also, in the optical fiber 1 with the ferrule of the embodiment, transmittance of the resin constructing the ferrule 20 is set at 1%/cm or less. The high-order mode light blurring to the ferrule 20 in the light transmitted in the optical fiber 10 is attenuated by the resin of the ferrule 20. As a result, the high-order mode light is resistant to being propagated. Accordingly, the optical fiber 1 with the ferrule having good transmission characteristics is provided.

### Modified Example 1

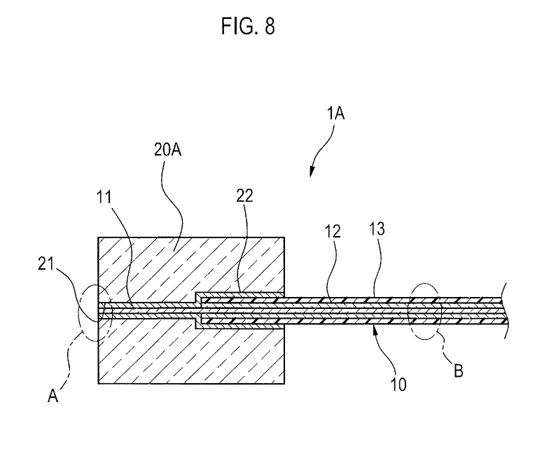

In addition, in the example described above, the example of the configuration in which the ferrule 20 is constructed integrally to the optical fiber 10 and the resin constructing the ferrule 20 directly abuts on the optical fiber 10 is described, but the invention is not limited to this example. FIG. 8 is an enlarged view of the end of an optical fiber 1A with a ferrule in a longitudinal direction according to a modified example 1 of the invention.

As shown in FIG. 8, in the optical fiber 1A with the ferrule according to the present modified example, the inside of a ferrule 20A may be provided with a through hole 21 and an optical fiber 10 may be fixed to this through hole 21 by an adhesive 22.

In a configuration shown in FIG. 8, in the end A of the optical fiber 1A with the ferrule in the longitudinal direction, a cladding part 12 and a coating part 13 are removed to expose a core part 11. The adhesive 22 is bonded to an outer peripheral surface of the exposed core part 11. The cladding part 12 and the coating part 13 correspond to a plastic part.

In the present modified example, the adhesive 22 having a refractive index higher than that of the cladding part 12 is used. Accordingly, the optical fiber with the ferrule in which a numeral aperture of the end A in the longitudinal direction is smaller than a numeral aperture of the center B in the longitudinal direction as described above can be obtained.

### Modified Example 2

Also, in the embodiment described above, the example in which the refractive index of of the ferrule 20 is set at the same value as a refractive index of the outermost periphery of the core part 11 so as to be continuous with refractive index distribution of the core part 11 is described, but the invention is not limited to this example. There may be a difference between the ferrule 20 and the outermost periphery of the core part 11 in a refractive index.

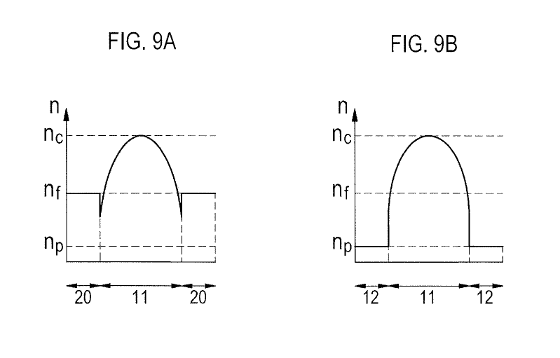

FIGS. 9A and 9B are diagrams showing refractive index distribution of an optical fiber with a ferrule according to a modified example 2 of the invention, and FIG. 9A shows refractive index distribution of the end in a longitudinal direction, and FIG. 9B shows refractive index distribution of the center in the longitudinal direction.

As shown in FIG. 9A, a refractive index of the ferrule 20 may be set at a value lower than a refractive index of the center of the core part 11 and higher than a refractive index of the outermost periphery of the core part 11. Accordingly, NA of the end of the optical fiber 1 with the ferrule in the longitudinal direction can also be set smaller than NA of the center in the longitudinal direction.

### Modified Example 3

Also, in the third embodiment described above, the example using the optical fiber 10 in which the core part 11 is made of glass and the cladding part 12 and the coating part 13 are made of plastic is described, but the invention is not limited to this example.

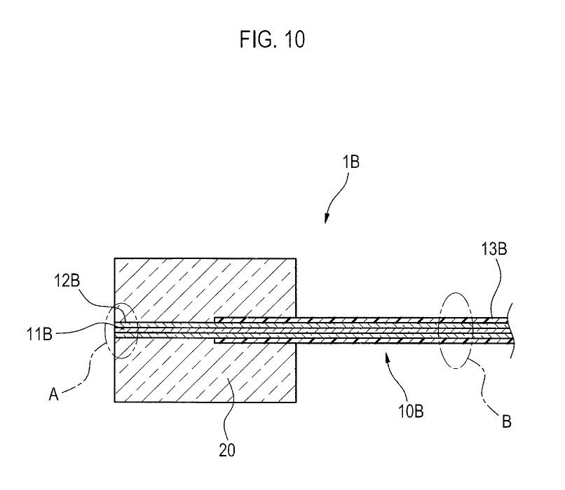

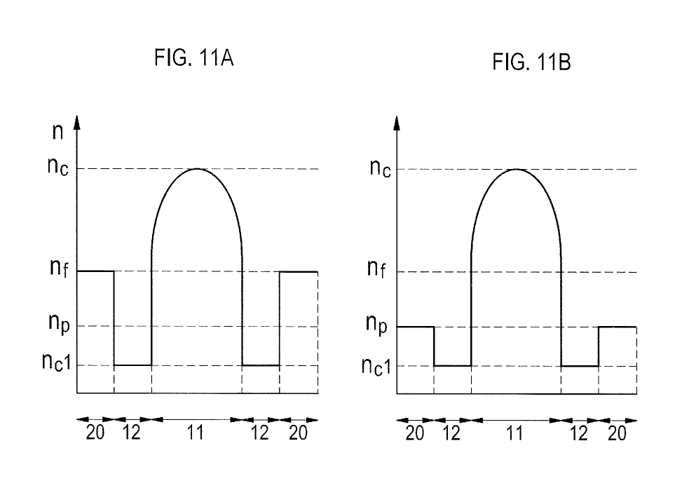

FIG. 10 is an enlarged view of the end of an optical fiber 1B with a ferrule in a longitudinal direction according to a modified example 3 of the invention. FIGS. 11A and 11B are diagrams showing refractive index distribution of the optical fiber 1B with the ferrule shown in FIG. 10 in a radial direction, and FIG. 11A shows refractive index distribution of the end A of the optical fiber 1B with the ferrule in a longitudinal direction, and FIG. 1 1B shows refractive index distribution of the portion B other than the end in the longitudinal direction.

In the present modified example, a core part 11B and a cladding part 12B of an optical fiber 10B are made of quartz glass, and a coating part 13B is made of plastic. The coating part 13B corresponds to a plastic part of the outside of the core part 11B. Also, a thickness of the cladding part 12B is set at 10 μm or less.

Inside a ferrule 20, in the end A of the optical fiber 10B in the longitudinal direction, the coating part 13B is removed and an outer peripheral surface of the cladding part 12B directly abuts on a resin constructing the ferrule 20.

As shown in FIGS. 11A and 11B, a refractive index of of the ferrule 20 is set higher than a refractive index np of the coating part 13B which is the plastic part. Since the cladding part 12B is thin, high-order mode light blurring from the cladding part 12B to the outside passes through the ferrule 20 with a high refractive index. As a result, a numeral aperture NA of the end A in the longitudinal direction becomes smaller than a numeral aperture NA of the center B, and good transmission characteristics can be obtained.

### Modified Example 4

Also, all of a core part 11, a cladding part 12 and a coating part 13 may be made of plastic. In this case, the cladding part 12 or the cladding part 12 and the coating part 13 correspond to a plastic part of the outside of the core part 11.

In this case, in the end of an optical fiber with a ferrule in a longitudinal direction, the plastic part is removed, and the end of an optical fiber 10 in which the plastic part is removed directly abuts on a resin constructing a ferrule 20. By setting a refractive index of the resin constructing the ferrule 20 higher than a refractive index of the plastic part, a numeral aperture of the end of the optical fiber with the ferrule in the longitudinal direction becomes smaller than a numeral aperture of the portion other than the end in the longitudinal direction.

In the example described above, the example of the GI fiber in which a refractive index of the core part 11 changes in a radial direction is given, but an SI fiber in which a refractive index does not change in a radial direction may be used.

What is claimed is:

1. An optical fiber with a ferrule, comprising:
an optical fiber having a core part and a cladding part; and
a ferrule to which an end of the optical fiber is fixed,
wherein the ferrule is formed integrally to the optical fiber and a resin constructing the ferrule directly abuts on the optical fiber.

2. The optical fiber with a ferrule according to claim 1, wherein
a refractive index of the ferrule is higher than a refractive index of the cladding part or the core part.

3. The optical fiber with a ferrule according to claim 1, wherein
transmittance of light at a wavelength of 850 nm to 1600 nm of the ferrule is lower than transmittance of light at the same wavelength of the cladding part or the core part.

4. The optical fiber with a ferrule according to claim 3, wherein
transmittance of light at a wavelength of 1300 nm to 1600 nm of the ferrule is lower than transmittance of light at the same wavelength of the cladding part or the core part.

5. The optical fiber with a ferrule according to claim 1, wherein
the ferrule have a fiber covering part with which the end of the optical fiber is covered, and a lens surface is formed on the fiber covering part of the ferrule.

6. The optical fiber with a ferrule according to claim 1, wherein
an end face of the optical fiber is a convex curved surface.

7. A manufacturing method of an optical fiber with a ferrule, comprising:
preparing a mold for forming a ferrule;
inserting an optical fiber and a resin constructing the ferrule into the mold; and
curing the resin and integrating the optical fiber with the ferrule.

8. The manufacturing method of an optical fiber with a ferrule according to claim 7, wherein
an optical fiber is inserted into the mold filled with the resin constructing the ferrule to cure the resin.

9. The manufacturing method of an optical fiber with a ferrule according to claim 7, wherein
the optical fiber is arranged in the mold after the optical fiber is cut by a laser.

10. An optical fiber with a ferrule, comprising:
an optical fiber including a core part, and a plastic part formed on an outside of the core part; and
a ferrule formed on an end of the optical fiber,
wherein the ferrule is fixed to an end of the optical fiber in which the plastic part is removed by an adhesive with a refractive index higher than that of the plastic part.

11. An optical fiber with a ferrule, comprising:
an optical fiber including a core part, and a plastic part formed on an outside of the core part; and
a ferrule fixed to an end of the optical fiber,
wherein a resin constructing the ferrule directly abuts on an end of the optical fiber in which the plastic part is removed, and the resin constructing the ferrule has a refractive index higher than that of the plastic part.

12. The optical fiber with a ferrule according to claim 10, wherein
refractive index distribution of the core part in a radial direction is α-power profile.

13. The optical fiber with a ferrule according to claim 10, wherein
the plastic part is a cladding part of the optical fiber.

14. The optical fiber with a ferrule according to claim 10, wherein
the core part is made of a resin.

15. The optical fiber with a ferrule according to claim 10, wherein
the optical fiber has a cladding part which is formed on an outside of the core part and is made of glass with a refractive index lower than that of the core part,
the plastic part of the optical fiber is a coating layer with which the cladding part is covered, and
a thickness of the cladding part may be 10 μm or less.

16. The optical fiber with a ferrule according to claim 10, wherein
transmittance of light at a wavelength of 850 nm to 1600 nm of the adhesive is 1%/cm or less.

17. The optical fiber with a ferrule according to claim 11, wherein
transmittance of light at a wavelength of 850 nm to 1600 nm of the resin constructing the ferrule is 1%/cm or less.

18. The optical fiber with a ferrule according to claim 10, wherein
a refractive index of the adhesive is lower than a refractive index of the core part.

19. The optical fiber with a ferrule according to claim 11, wherein
a refractive index of the resin constructing the ferrule is lower than a refractive index of the core part.

20. The optical fiber with a ferrule according to claim 11, wherein
refractive index distribution of the core part in a radial direction is α-power profile.

21. The optical fiber with a ferrule according to claim 11, wherein
the plastic part is a cladding part of the optical fiber.

22. The optical fiber with a ferrule according to claim 11, wherein
the core part is made of a resin.

23. The optical fiber with a ferrule according to claim 11, wherein
the optical fiber has a cladding part which is formed on an outside of the core part and is made of glass with a refractive index lower than that of the core part,
the plastic part of the optical fiber is a coating layer with which the cladding part is covered, and
a thickness of the cladding part may be 10 μm or less.
